(19) United States
(12) Patent Application Publication
(10) Pub. No.: US 2007/0261098 A1
(43) Pub. Date: Nov. 8, 2007

(54) Digital Broadcasting Receiver and Driving Method Thereof

(76) Inventors: Dong Il Lee, Seoul (KR); Min Young Yang, Seoul (KR)

Correspondence Address: BIRCH STEWART KOLASCH & BIRCH, PO BOX 747, FALLS CHURCH, VA, 22040-0747, US

(21) Appl. No.: 11/577,353

(22) PCT Filed: Nov. 16, 2005
(86) PCT No.: PCT/KR05/03885

§ 371 Date: Apr. 16, 2007

(30) Foreign Application Priority Data
Nov. 16, 2004 (KR) 10-2004-0093673

(51) Int. Cl. H04N 7/16

(52) U.S. Cl. 725/151; 725/153

(57) ABSTRACT

A digital broadcasting receiver includes a data broadcasting engine receiving to execute a game program transferred by being included in digital broadcasting and an input/output interface transferring the game program to a connected record medium. A digital broadcasting receiver includes an input/output interface receiving a game program from a connected record medium and a data broadcasting engine executing the received game program. A method of driving a digital broadcasting receiver includes receiving to execute a game program transferred by being included in digital broadcasting and storing the received game program in a connected record medium. A method of driving a digital broadcasting receiver includes receiving a game program from a connected record medium and executing the received game program in a data broadcasting engine.

### TECHNICAL FIELD

The present document relates to a digital broadcasting receiver and driving method thereof.

### BACKGROUND ART

Generally, data broadcasting is new type of broadcasting according to the introduction of digital broadcasting era. Of course, a sort of data broadcasting such as a teletext was also operated in Europe in the age of analog broadcasting.

Yet, digital data broadcasting is superior to analog broadcasting in graphics and is developing into a system capable of transmitting execution code from simple data transfer. For this, a representative example of a data broadcasting engine is the British data broadcasting standard of MHEG-5 (multimedia & hypermedia information coding expert group-5) or DVB-MHP (digital video broadcasting—multimedia home platform).

The core of the MHEG or MHP is the implementation of interpreter. In case of MHEG-5, it is ‘MHEG-5 engine’. In case of MHP, it is ‘Java’.

A data broadcasting engine receives execution codes in a form independent from a hardware platform and converts it to a code suitable for the driven hardware platform to execute. Hence, broadcasting stations in the digital broadcasting era can transmit application programs to users through data broadcasting.

However, although a digital broadcasting receiver is capable of receiving such an application program as a game program via data broadcasting, the received game program is not stored. Hence, the game program needs to be received again each time a user wants.

And, since the received game program is not stored, it is impossible to keep user data associated with the game program. Moreover, if a schedule of the data broadcasting provided from a broadcasting station is changed, it is unable to enjoy the previous game program anymore.

### DISCLOSURE OF INVENTION

Technical Problem

The object of the present invention is to provide a digital broadcasting receiver and driving method thereof, by which a game program received via digital broadcasting can be stored in a record medium.

Another object of the present invention is to provide a game system and record medium implementing the same, by which a game program stored in a record medium can be executed using a digital broadcasting receiver.

Technical Solution

To achieve these and other advantages and in accordance with the purpose of the present invention, a digital broadcasting receiver includes a data broadcasting engine receiving to execute a game program transferred by being included in digital broadcasting and an input/output interface transferring the game program to a connected record medium.

In another aspect of the present invention, a digital broadcasting receiver includes an input/output interface receiving a game program from a connected record medium and a data broadcasting engine executing the received game program.

In another aspect of the present invention, a method of driving a digital broadcasting receiver includes ; receiving to execute a game program transferred by being included in digital broadcasting and storing the received game program in a connected record medium.

In another aspect of the present invention, a method of driving a digital broadcasting receiver includes ; receiving a game program from a connected record medium and executing the received game program in a data broadcasting engine.

In another aspect of the present invention, a game system includes a record medium storing a game program, an input/output interface receiving the game program stored in the record medium, and a data broadcasting engine executing the received game program.

In another aspect of the present invention, a record medium, in which a game program is stored, is connected to a digital broadcasting receiver to enable the game program to be executed in a data broadcasting engine provided to the digital broadcasting receiver.

Advantageous Effects

In the present invention, a record medium enabling a stored game program to be executed using a digital broadcasting receiver is proposed. And, a method of storing a data broadcasting game program transmitted over data broadcasting in the record medium is proposed.

According to the present invention, a user can enjoy a game program in a digital broadcasting receiver by utilizing a record medium without having time and space limitations.

According to the present invention, a game program provided over digital broadcasting is stored in a record medium to be enjoyed again if necessary.

### BRIEF DESCRIPTION OF THE DRAWINGS

FIG. 1 is a diagram for explaining an example of executing a game program in a digital broadcasting receiver according to an embodiment of the present invention; and

FIG. 2 is a diagram for explaining an example of executing a game program in a digital broadcasting receiver according to another embodiment of the present invention.

### MODE FOR THE INVENTION

Reference will now be made in detail to one preferred embodiment of the present invention, examples of which are illustrated in the accompanying drawings.

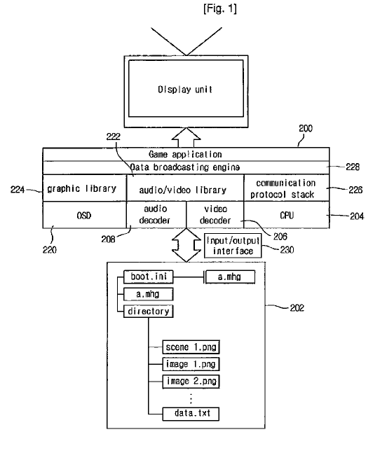

FIG. 1 is a diagram for explaining an example of executing a game program in a digital broadcasting receiver according to an embodiment of the present invention.

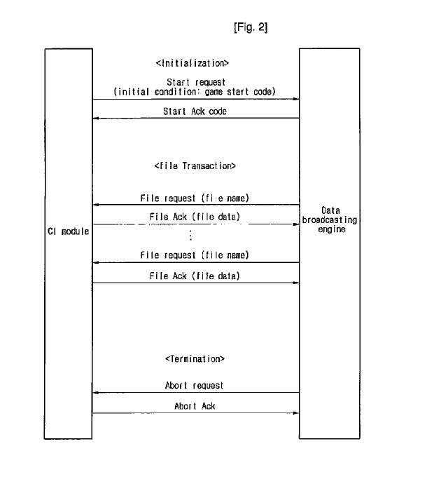

Referring to FIG. 2, a digital broadcasting receiver 200 according to the present invention includes a CPU (central processing unit) 204, a video decoder 206, an audio decoder 208 and an OSD (on screen display) 220.

The digital broadcasting receiver 200 according to the present invention includes an audio/video library 222, a graphic library 224 and a communication protocol stack 226. In this case, the communication protocol stack includes a CI (common interface) protocol stack, a DSM CC (digital video broadcasting-command & control) stack and a USB (universal serial bus) protocol stack.

And, the digital broadcasting receiver 200 according to the present invention includes a data broadcasting engine 228. The data broadcasting engine 228 is not driven dependent on a specific CPU and is a virtual machine interpreter enabling a processing of a machine independent code.

Namely, although the digital broadcasting receiver 200 receiving data broadcasting receives a regulated application code, since a species of the CPU 204 is diversely employable, it may happen that data cannot be read. In this case, the data broadcasting engine 228 is provided between the regulated application code and the diverse CPU 204 to play a role in helping to read the code.

As a representative data broadcasting engine 228, there is ‘MHEG-5 engine’ or ‘MHP JVM (Java virtual machine)’. A broadcasting application program including a game program transmitted from a broadcasting station is driven on the data broadcasting engine 228.

One method of executing a game program in the above-configured digital broadcasting receiver 200 according to the present invention is explained as follows.

Referring to FIG. 1, a record medium 202 is connected to an input/output interface 230 of the digital broadcasting receiver 200 according to the present invention. The record medium 202 may be a built-in record medium provided within the digital broadcasting receiver 200 or an external type record medium connected to an exterior of the digital broadcasting receiver 200. And, the record medium 202 may be a portable record medium.

The record medium 202, which is connected to the input/output interface 230 of the digital broadcasting receiver 200 according to the present invention to use, may be called a game memory-pack. A USB flash memory can be used as a simple example of the game memory-pack.

A storage space is provided to the record medium 202 to store a game program. And, a storage space for storing user data associated with the game program may be provided to the record medium 202.

And, a processor for transferring a file and user data necessary for a game program drive in the digital broadcasting receiver 200 can be embedded in the record medium 202, as well as the storage spaces.

First of all, explained in the following is a case that a passive type game memory-pack simply having a storage space is applied. As an example of the passive type game memory-pack, there is a USB flash memory. The USB flash memory is connected to the digital broadcasting receiver 200 via the input/output interface 230. The digital broadcasting receiver 200 accesses the USB flash memory via the USB protocol stack to read and write a file.

By the present invention, the record medium 202 is plugged in the input/output interface 230 of the digital broadcasting receiver 200 to enable a specific application program, e.g., a game program to be executed. To implement this, an initial file should be designated so that the data broadcasting engine 228 can boot up the specific application program. And, information about the specified boot-up file should be provided to the data broadcasting engine 228.

Namely, since the game memory-pack is a passive type, the data broadcasting engine 228 should find an initial boot-up file. For this, a ‘boot.ini’ file is placed in a root directory of the record medium 202 to designate the initial boot-up file.

For instance, a content of ‘boot.ini’ is displayed right to ‘boot.ini’ in FIG. 1. And, the content is ‘a.mhg’. This provides information that a name of a file to be initially booted up is ‘a.mhg’.

Hence, the data broadcasting engine 228 acquires ‘a.mhg’ set for ‘boot.ini’ and then a boot-up process is executed from the acquisition. Other files stored in the record medium 202 are necessary for an execution process of a corresponding application program, and are loaded in the digital broadcasting receiver 200 to be processed if necessary. Theses files include an image file and a character file.

Meanwhile, a processor for file handling can be embedded in the record medium 202 connected to the digital broadcasting receiver 200 according to the present invention. A CI (common interface) module as an example of the record medium 202 having the processor embedded therein is explained as follows.

The digital broadcasting receiver 200 become capable of transferring signals to the CI module via the communication protocol stack 226, e.g., the CI (common interface) protocol stack. For instance, the record medium having the processor embedded therein can be implemented as ‘application MMI (man machine interface)’ of DVB-CI (digital video broadcasting common interface).

A process of transferring data between the CI module and the data broadcasting engine is shown in FIG. 2. FIG. 2 is a diagram for explaining an example of executing a game program in a digital broadcasting receiver according to another embodiment of the present invention.

An active game memory-pack provided with the above-explained processor can be implemented as ‘application MMI’ of DVB-CI (digital video broadcasting—common interface).

Referring to FIG. 2, each progress step is mainly divided into three steps. The three steps include an initialization step, a file transaction step and a termination step.

In the initialization step, a file name for a start-up code of a stored game program is delivered from a CI module to the data broadcasting engine 228.

Subsequently, the data broadcasting engine 228 of the digital broadcasting receiver 200 can acquire a corresponding file from the CI module in the file transaction step. By the file transfer, the game program can be executed.

Namely, necessary corresponding files are transferred in the file transaction step. If the data broadcasting receiver 228 requests the CI module for a file, the CI module transfers data of the requested file to the data broadcasting engine 228.

The file transaction step is repeatedly executed until the corresponding files necessary for driving the game program are completely transacted.

Subsequently, the data broadcasting engine 228 requests the CI module for abort to handle the termination step as a final step.

Meanwhile, by the present invention, as mentioned in the foregoing description, the game program is driven by reading the files stored in the record medium 202 via the input/output interface 230 of the digital broadcasting receiver 200. And, a data broadcasting game program received from a broadcasting station can be stored in the record medium via the input/output interface 230 as well.

The communication protocol stack located at a lower end of the data broadcasting engine 228 shown in FIG. 1 includes a DSM CC (digital video broadcasting command & control) stack. The DSM CC stack is a protocol stack to receive data broadcasting. The data broadcasting game program is stored via the DSM CC stack. Various files necessary for the game program are temporarily stored in a RAM of the digital broadcasting receiver 200.

In general cases, such a game program is erased from the RAM if power of the digital broadcasting receiver 200 is turned off. For instance, if a user-favorite game program is not broadcast in the next time, a user is unable to play the corresponding game program anymore.

Yet, by the present invention, the received game program can be stored in the connected record medium 202. Hence, the game program can be executed via the digital broadcasting receiver 200 in a user-specific time and space.

As mentioned in the foregoing description, if the files of the data broadcasting game program stored in the RAM are transferred to the connected record medium 202 to be stored in a form of directory structure (tree structure), a user can store the data broadcasting game program forever. And, the user data for the game program can be stored in the record medium 202 together. Hence, the game program provided over digital broadcasting can be stored in the record medium 202 to be enjoyed if necessary.

For the proceeding of the boot-up process thereafter, a name of an initial file necessary for an application program boot-up should be written on the ‘boot.ini’ file.

### INDUSTRIAL APPLICABILITY

In the present invention, a record medium enabling a stored game program to be executed using a digital broadcasting receiver is proposed. And, a method of storing a data broadcasting game program transmitted over data broadcasting in the record medium is proposed.

According to the present invention, a user can enjoy a game program in a digital broadcasting receiver by utilizing a record medium without having time and space limitations.

According to the present invention, a game program provided over digital broadcasting is stored in a record medium to be enjoyed again if necessary.

1. A digital broadcasting receiver comprising:
a data broadcasting engine receiving to execute a game program transferred by being included in digital broadcasting; and
an input/output interface transferring the game program to a connected record medium.

2. The digital broadcasting receiver of claim 1, wherein the record medium includes a built-in record medium, an external type record medium and a portable record medium.

3. The digital broadcasting receiver of claim 1, wherein the game program is transferred over the data broadcasting.

4. The digital broadcasting receiver of claim 1, wherein the game program transferred via the input/output interface is processed by a communication protocol stack.

5. The digital broadcasting receiver of claim 4, wherein the communication protocol stack includes a CI (common interface) protocol stack, a DSM CC (digital video broadcasting-command & control) stack and a USB (universal serial bus) protocol stack.

6. The digital broadcasting receiver of claim 1, wherein user data associated with the game program is transferred to the connected record medium.

7. A digital broadcasting receiver comprising:
an input/output interface receiving a game program from a connected record medium; and
a data broadcasting engine executing the received game program.

8. The digital broadcasting receiver of claim 7, wherein the record medium includes a built-in record medium, an external type record medium and a portable record medium.

9. The digital broadcasting receiver of claim 7, wherein the game program received via the input/output interface is processed by a communication protocol stack.

10. The digital broadcasting receiver of claim 9, wherein the communication protocol stack includes a CI (common interface) protocol stack, a DSM CC (digital video broadcasting-command & control) stack and a USB (universal serial bus) protocol stack.

11. The digital broadcasting receiver of claim 7, wherein user data associated with the game program is transferred from the connected record medium.

12. A method of driving a digital broadcasting receiver, comprising:
receiving to execute a game program transferred by being included in digital broadcasting; and
storing the received game program in a connected record medium.

13. The method of claim 12, wherein the record medium includes a built-in record medium, an external type record medium and a portable record medium.

14. The method of claim 12, wherein the game program is transferred over the data broadcasting.

15. The method of claim 12, wherein the game program transferred to the record medium is processed by a communication protocol stack.

16. The method of claim 15, wherein the communication protocol stack includes a CI (common interface) protocol stack, a DSM CC (digital video broadcasting-command & control) stack and a USB (universal serial bus) protocol stack.

17. The method of claim 12, wherein user data associated with the game program is transferred to the connected record medium.

18. A method of driving a digital broadcasting receiver, comprising:
receiving a game program from a connected record medium; and
executing the received game program in a data broadcasting engine.

19. The method of claim 18, wherein the record medium includes a built-in record medium, an external type record medium and a portable record medium.

20. The method of claim 18, wherein the received game program is processed by a communication protocol stack.

21. The method of claim 20, wherein the communication protocol stack includes a CI (common interface) protocol stack, a DSM CC (digital video broadcasting-command & control) stack and a USB (universal serial bus) protocol stack.

22. The method of claim 18, wherein user data associated with the game program is transferred from the connected record medium.

23. The method of claim 18, wherein the data broadcasting engine receives the game program from the record medium by a plug-in system.

24. The method of claim 18, wherein the data broadcasting engine loads the game program with reference to a boot-up file recorded in the record medium.

25. The method of claim 18, wherein the data broadcasting engine loads the game program via communications with a processor provided to the record medium.

26. A game system comprising:
a record medium storing a game program;
an input/output interface receiving the game program stored in the record medium; and
a data broadcasting engine executing the received game program.

27. The game system of claim 26, wherein the record medium includes a built-in record medium, an external type record medium and a portable record medium.

28. The game system of claim 26, wherein the received game program is processed by a communication protocol stack.

29. The game system of claim 28, wherein the communication protocol stack includes a CI (common interface) protocol stack, a DSM CC (digital video broadcasting-command & control) stack and a USB (universal serial bus) protocol stack.

30. The game system of claim 26, wherein user data associated with the game program is transferred from the record medium.

31. The game system of claim 26, wherein the data broadcasting engine receives the game program from the record medium by a plug-in system.

32. The game system of claim 26, wherein the data broadcasting engine loads the game program with reference to a boot-up file recorded in the record medium.

33. The game system of claim 26, wherein the data broadcasting engine loads the game program via communications with a processor provided to the record medium.

34. The game system of claim 26, wherein user data associated with the game program is stored in the connected record medium.

35. A record medium, in which a game program is stored, the record medium connected to a digital broadcasting receiver to enable the game program to be executed in a data broadcasting engine provided to the digital broadcasting receiver.

36. The record medium of claim 35, wherein the game program is a data broadcasting game program.

37. The record medium of claim 35, further comprising a processor for data transfer with the digital broadcasting receiver.
